(19) United States
(12) Patent Application Publication
(10) Pub. No.: US 2025/0030013 A1
(43) Pub. Date: Jan. 23, 2025

(54) FUEL CELL WITH SERPENTINE WITH-IN SERPENTINE FLOW FIELD CHANNELS

(71) Applicant: Toyota Motor Engineering & Manufacturing North America, Inc., Plano, TX (US)

(72) Inventors: Utsav Raj Aryal, Ypsilanti, MI (US); Gaohua Zhu, Ann Arbor, MI (US)

(73) Assignees: Toyota Motor Engineering & Manufacturing North America, Inc., Plano, TX (US); Toyota Jidosha Kabushiki Kaisha, Toyota-Shi (JP)

(21) Appl. No.: 18/356,799

(22) Filed: Jul. 21, 2023

(51) Int. Cl. H01M 8/0263

(52) U.S. Cl. CPC H01M 8/0263

(57) ABSTRACT

An apparatus for a fuel cell may include a plurality of flow field channels, wherein the plurality of flow field channels may include a plurality of ribs connecting an inlet and an outlet in a serpentine flow design. The plurality of flow field channels may further include a plurality of blocking ribs within the plurality of ribs. A method for creating a fuel cell may include creating a fuel cell with a plurality of flow field channels, wherein the plurality of flow field channels may include a plurality of ribs forming a serpentine flow design from an inlet to an outlet, and a plurality of blocking ribs within the plurality of ribs.

### BACKGROUND

Flow field (FF) channels are typically engraved in bipolar plates or within gas diffusion media in the fuel cells, which is for the transport of reactants and products to/from the cell respectively.

### SUMMARY

In one example implementation, a method may include but is not limited to creating a fuel cell with a plurality of flow field channels, wherein the plurality of flow field channels may include a plurality of ribs forming a serpentine flow design from an inlet to an outlet, and a plurality of blocking ribs within the plurality of ribs.

One or more of the following example features may be included. At least a portion of the plurality of blocking ribs within the plurality of ribs may be attached to one of a plate and the plurality of ribs. The plurality of blocking ribs attached to the plurality of ribs may include a first set of blocking ribs attached to an upper portion of the plurality of ribs. The plurality of blocking ribs attached to the plurality of ribs may further include a second set of blocking ribs attached to a lower portion of the plurality of ribs. Gases may flow in a serpentine pattern of the blocking ribs within the serpentine pattern of the plurality of ribs. The plurality of blocking ribs within the plurality of ribs may be congruent.

In another example implementation, an apparatus may include but is not limited to a plurality of flow field channels, wherein the plurality of flow field channels may include a plurality of ribs connecting an inlet and an outlet in a serpentine flow design. The plurality of flow field channels may further include a plurality of blocking ribs within the plurality of ribs.

One or more of the following example features may be included. At least a portion of the plurality of blocking ribs within the plurality of ribs may be attached to a plate. At least a portion of the plurality of blocking ribs within the plurality of ribs may be attached to the plurality of ribs. The plurality of blocking ribs attached to the plurality of ribs may include a first set of blocking ribs attached to an upper portion of the plurality of ribs. The plurality of blocking ribs attached to the plurality of ribs may further include a second set of blocking ribs attached to a lower portion of the plurality of ribs. Gases may flow in a serpentine pattern of the blocking ribs within the serpentine pattern of the plurality of ribs. The plurality of blocking ribs within the plurality of ribs may be congruent.

In another example implementation, a fuel cell may include but is not limited to a plurality of flow field channels, wherein the plurality of flow field channels may include a plurality of ribs connecting an inlet and an outlet in a serpentine flow design. The plurality of flow field channels may further include a plurality of blocking ribs within the plurality of ribs.

One or more of the following example features may be included. At least a portion of the plurality of blocking ribs within the plurality of ribs may be attached to a plate. At least a portion of the plurality of blocking ribs within the plurality of ribs may be attached to the plurality of ribs. The plurality of blocking ribs attached to the plurality of ribs may include a first set of blocking ribs attached to an upper portion of the plurality of ribs. The plurality of blocking ribs attached to the plurality of ribs may further include a second set of blocking ribs attached to a lower portion of the plurality of ribs. Gases may flow in a serpentine pattern of the blocking ribs within the serpentine pattern of the plurality of ribs. The plurality of blocking ribs within the plurality of ribs may be congruent.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF DRAWINGS

FIG. 1 is an example diagrammatic view of a serpentine flow field (FF) channel design;

FIG. 2 is an example flowchart of a FF process according to one or more example implementations of the disclosure;

FIG. 3 is an example diagrammatic view of a serpentine with-in serpentine (SWIS) FF channel design according to one or more example implementations of the disclosure;

FIGS. 4A-B are example diagrammatic views of blocking ribs of a SWIS FF channel design according to one or more example implementations of the disclosure;

FIG. 5 is an example chart of polarization curves for a serpentine FF design and a SWIS FF channel design according to one or more example implementations of the disclosure; and

FIGS. 6A-B are example oxygen concentration charts for a serpentine FF design and a SWIS FF channel design according to one or more example implementations of the disclosure.

Like reference symbols in the various drawings may indicate like elements.

### DESCRIPTION

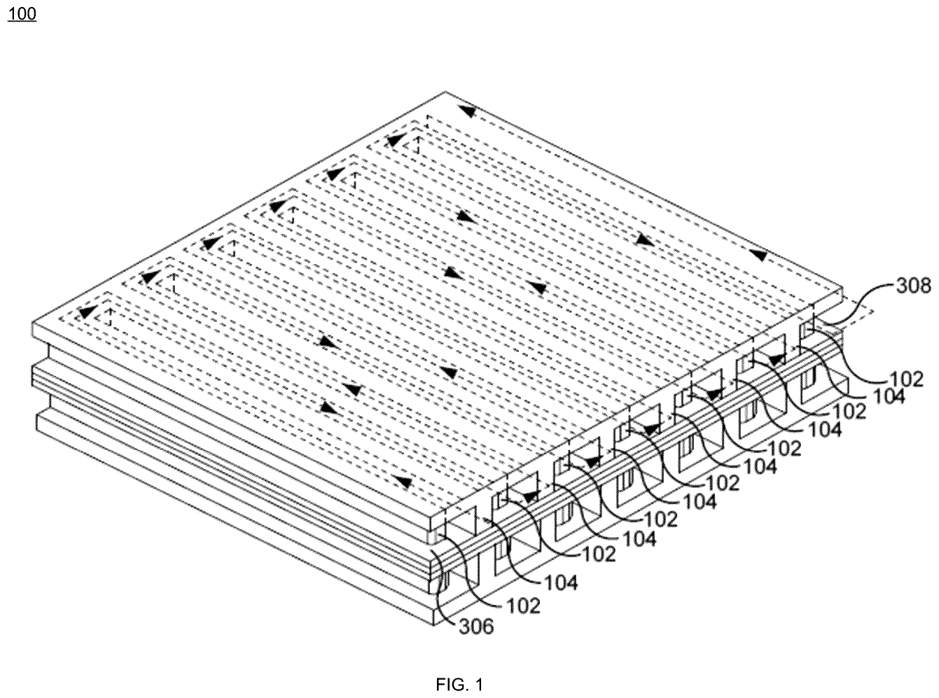

Flow field (FF) channels are typically engraved in bipolar plates or within gas diffusion media in the fuel cells, which is for the transport of reactants and products to/from the cell respectively. The design of the FF greatly affects the performance of the cell owing to its ability to diffuse the reactant oxygen and carry out the product water, especially on the cathode side. Serpentine FF channels are shown to perform better than the parallel and the interdigitated FF. For instance, and referring to FIG. 1, there is shown a schematic of a serpentine FF channel design 100, consisting of solid ribs 102, and channels 104 for the gas flow. Only the overall flow pattern from inlet 106 to outlet 108 is in serpentine form for conventional serpentine FF channels. Moreover, the current design of the serpentine FF channel still has non-uniform gas distribution, primarily under the ribs of the fuel cell.

Therefore, as will be discussed below, the present disclosure targets further improvement in the performance of the serpentine FF by incorporating blocking ribs in the flow direction at the cathode channel such that the gases flow in serpentine pattern within the serpentine pattern, thus, named Serpentine With-In Serpentine (SWIS) FF channel.

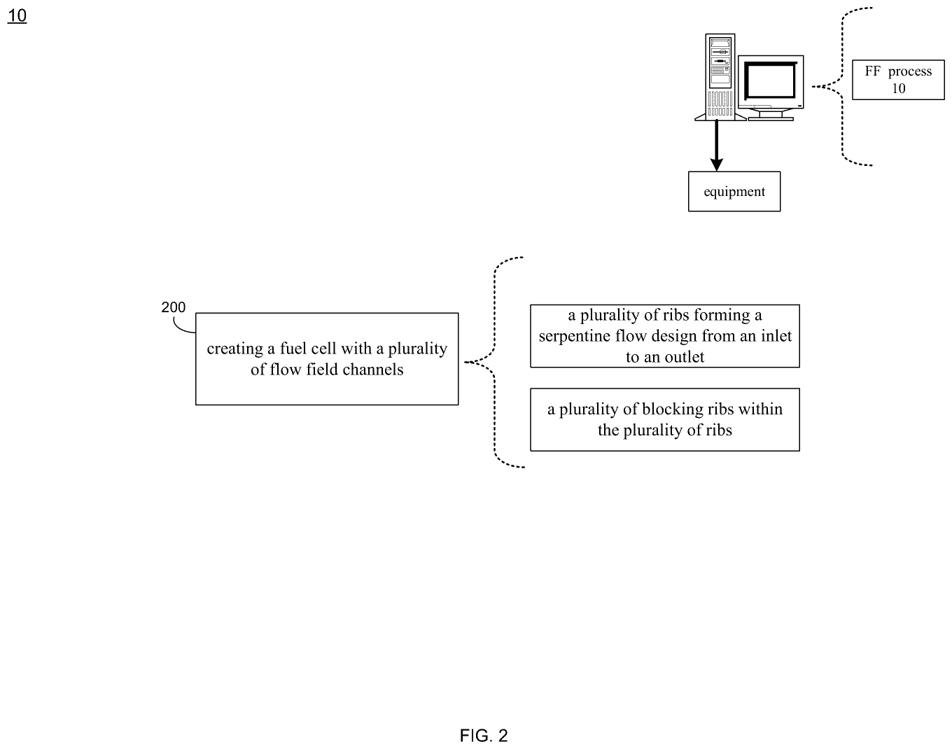

As discussed above and referring also at least to the example implementations of FIGS. 2-6, flow field (FF) process 10 may create 200 a fuel cell with a plurality of flow field channels, wherein the plurality of flow field channels may include a plurality of ribs forming a serpentine flow design from an inlet to an outlet, and a plurality of blocking ribs within the plurality of ribs.

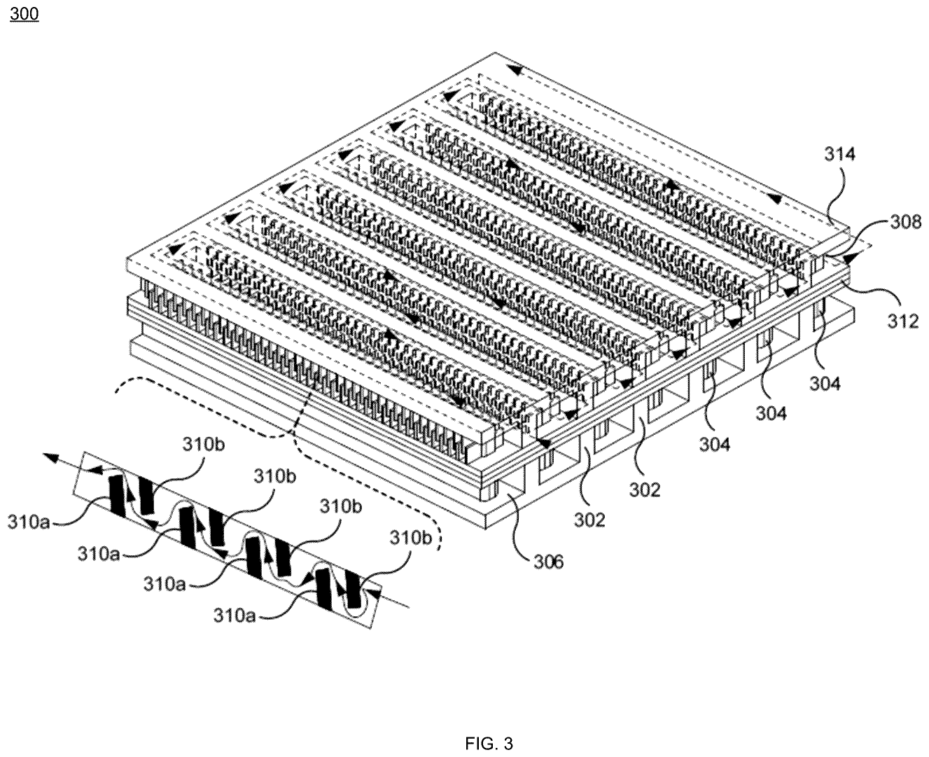

In some implementations, flow field (FF) process 10 may create 200 a fuel cell with a plurality of flow field channels, wherein the plurality of flow field channels may include a plurality of ribs forming a serpentine flow design from an inlet to an outlet, and a plurality of blocking ribs within the plurality of ribs. For instance, and referring at least to the example implementation of FIG. 3, an example schematic of an apparatus 300, i.e., a SWIS FF channel design apparatus, is shown. In the example, apparatus 300 includes solid ribs 302, and channels 304 for the gas flow. As will be discussed below, unlike the current design of the serpentine FF channel (where only the overall flow pattern from the inlet to outlet is in serpentine form), the SWIS FF design of the present disclosure has a flow pattern that is also in serpentine form (even in a singular channel) because of the blocking ribs within the channel. It will be appreciated after reading the present disclosure that blocking ribs 310a and 310b may be used in a single channel with a solid rib 302. That is, instead of multiple channels forming a serpentine design, a singular channel may be used (with the blocking ribs) to pass straight through to the other side. For clarify, the left side of the FIG. 3 is representation of one part of a long serpentine channel. To have a serpentine within serpentine kind of flow, it should have a base serpentine flow. Even the normal serpentine FF can be a long single channel, with bends like those represented in FIG. 1.

It will be appreciated after reading the present disclosure that any FF channel engraving/assembly/printing/fabrication, etc. equipment, as well as any other necessary equipment, may be used singly or in any combination with FF process 10, which may be operatively connected to a computing device, such as the computing device shown in FIG. 2, to obtain their instructions for creating one or more aspects of the present disclosure. In one or more example implementations, the respective flowcharts may be manually-implemented, computer-implemented, or a combination thereof. In some implementations, the SWIS FF design of the present disclosure may be manufactured all as one (e.g., using molds or 3D printing) or may be manufactured in pieces to be assembled at a later time.

In some implementations, gases may flow in a serpentine pattern of the blocking ribs within the serpentine pattern of the plurality of ribs. For instance, unlike the serpentine FF design of FIG. 1, which only the overall flow pattern from inlet 106 to outlet 108 is in serpentine form, the SWIS FF channel design has blocking ribs (e.g., blocking ribs 310a and 310b) in the flow direction at the cathode channel, such that the gases flow in serpentine pattern within the serpentine pattern from the inlet 306 to outlet 308. That is, in some implementations, the design of blocking ribs 310a and 310b shown in the expanded view of FIG. 3 follows the same or similar serpentine pattern shown by dashed lines and arrows, which gives the channels the SWIS FF channel design.

In some implementations, there may be multiple stacked SWIS FF channel designs. For instance, and still referring at least to FIG. 3, only the top portion is a SWIS FF channel and the bottom one is a normal serpentine. However, it can be stacked in different combinations as well (e.g., SWIS FF channel stacked on SWIS FF channel, etc.). As shown in FIG. 3, there may also be a membrane electrode assembly (MEA) 312. However, in a stack, can be separated by a plate (e.g., plate 314). It will be appreciated after reading the present disclosure that there may be more than two SWIS FF channel design stacks, or only one SWIS FF channel design, without departing from the scope of the present disclosure.

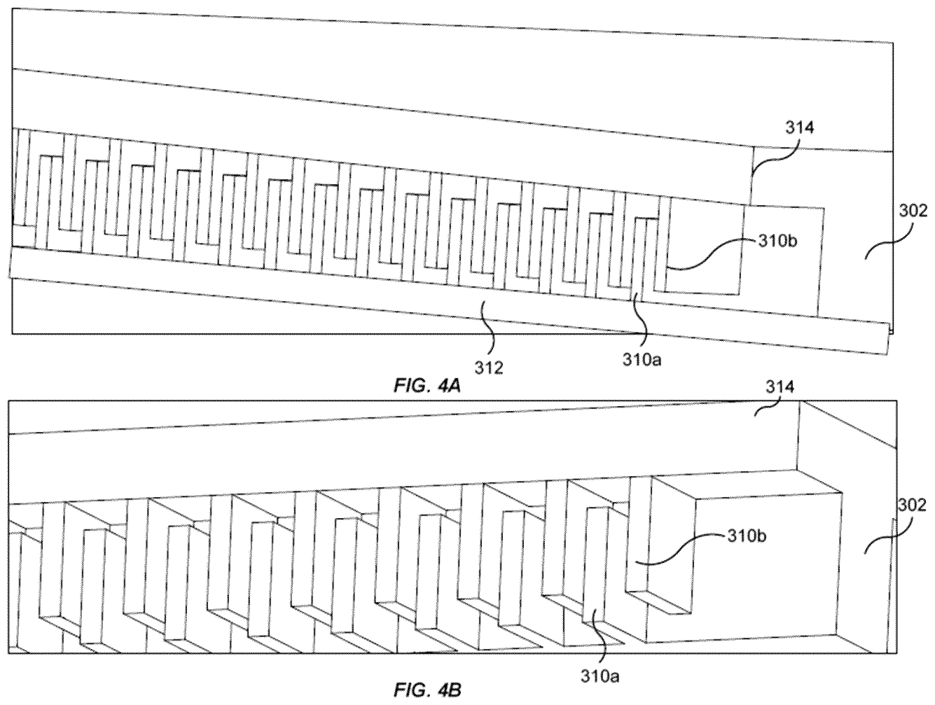

In some implementations, at least a portion of the plurality of blocking ribs within the plurality of ribs may be attached to a plate (e.g., plate 314), and at least a portion of the plurality of blocking ribs within the plurality of ribs may be attached to the plurality of ribs. For instance, and referring at least to the example implementation of FIG. 4A, an expanded view of blocking ribs 310a and 310b is shown. In the example, the blocking ribs (blocking ribs 310a) are attached to solid ribs 302, whereas the blocking ribs (blocking ribs 310b) are attached to plate 314 at a slightly lower position, which gives the channels the SWIS FF channel design.

In some implementations, the plurality of blocking ribs attached to the plurality of ribs may include a first set of blocking ribs attached to an upper portion of the plurality of ribs, and in some implementations, the plurality of blocking ribs attached to the plurality of ribs may further include a second set of blocking ribs attached to a lower portion of the plurality of ribs. For instance, and referring at least to the example implementation of FIG. 4B, an expanded view of blocking ribs 310a and 310b is shown. In the example, the first set of blocking ribs (blocking ribs 310b) are attached to solid ribs 302, and the second set of blocking ribs (blocking ribs 310a) are also attached to solid ribs 302, but at a slightly lower position, which gives the channels the SWIS FF channel design.

In some implementations, the plurality of blocking ribs within the plurality of ribs may be congruent. For instance, and still referring at least to the example implementation of FIGS. 4A-4B, it can be seen that blocking ribs 310a and blocking ribs 310b are congruent (same size and shape). However, it will be appreciated after reading the present disclosure that blocking ribs 310a and blocking ribs 310b may be different sizes and different shapes. For instance, blocking ribs 310a may be shorter than blocking ribs 310b. As another example, blocking ribs 310a may be longer than blocking ribs 310b. As another example, some blocking ribs 310a may be shorter than other blocking ribs 310a. Similarly, some blocking ribs 310b may be shorter than other blocking ribs 310b. As another example, blocking ribs 310a may be rectangular, whereas blocking ribs 310b may be square (or other shape). As another example, blocking ribs 310b may be rectangular (or other shape), whereas blocking ribs 310a may be square.

Therefore, as will be discussed below, the present disclosure targets further improvement in the performance of the serpentine FF by incorporating blocking ribs in the flow direction at the cathode channel such that the gases flow in serpentine pattern within the serpentine pattern, thus, named Serpentine With-In Serpentine (SWIS) FF channel. The SWIS FF may improve the reactant distribution increasing the overall performance. In some implementations, the SWIS FF channel design may be particularly beneficial to improvements in high temperature fuel cell performance for heavy duty vehicle operation, but other applications may be used as well. Unlike the current design of the serpentine FF channel, which has the issue of non-uniform gas distribution primarily under the ribs of the fuel cell, the SWIS design of the present disclosure has shown better reactant diffusion under the ribs due to increased pressure drop.

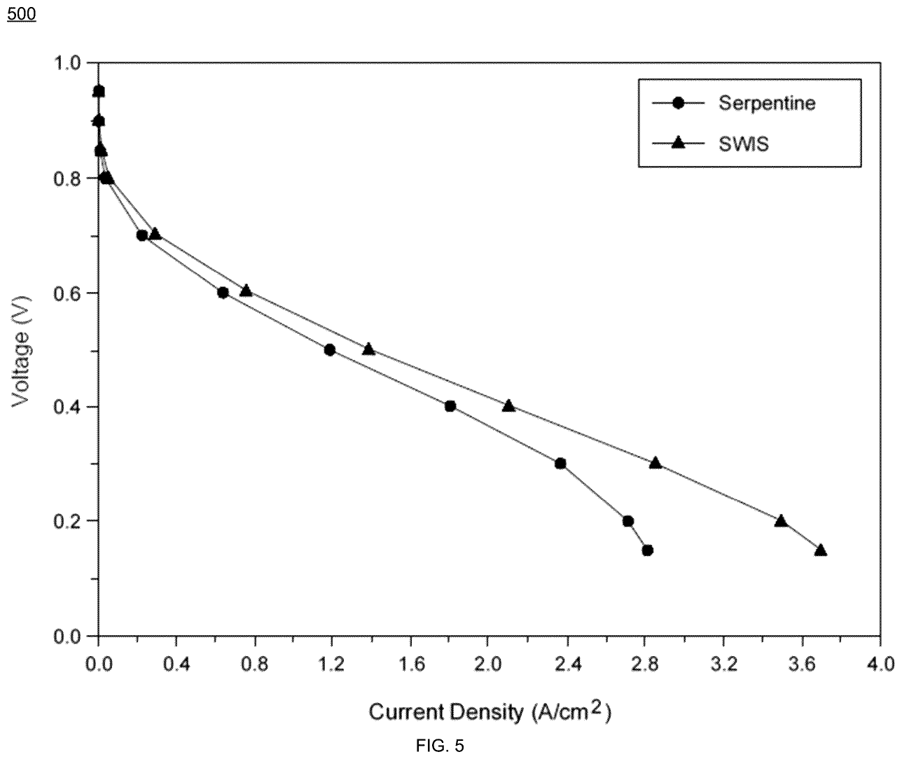

For example, and referring at least to the example FIG. 5, there is shown a chart 500 that represents the polarization curves for conventional serpentine and SWIS FF till 0.15 V, which clearly shows that the performance of the fuel cell can be improved by employing the example SWIS FF design of the present disclosure. For instance, an improvement of around, e.g., 32% for the limiting current density at 0.15 V may be obtained using the disclosed SWIS FF channel design, although more or less of an improvement may also be achieved without departing from the scope of the present disclosure.

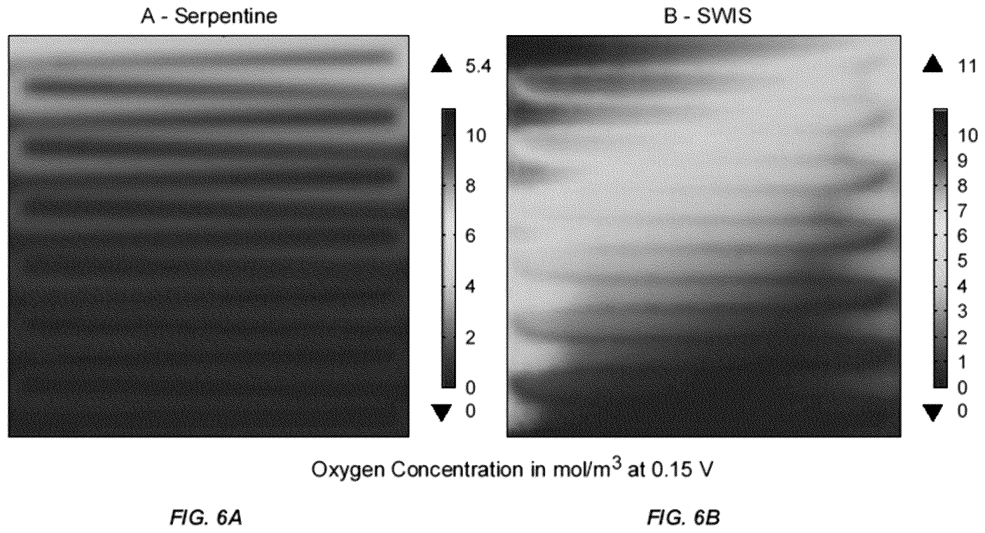

As another example of the improvements over conventional serpentine designs, FIGS. 6A and 6B show the oxygen concentration at the cathode catalyst layers for the two different FF designs. Going from the conventional serpentine design (A) shown on the left to the SWIS FF design of the present disclosure (B) shown on the right, the oxygen distribution can be seen as improved, which ultimately improves the corresponding current density obtained.

As will be appreciated by one skilled in the art after reading the present disclosure, the present disclosure may be embodied as a method, system, or computer program product. Accordingly, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, the present disclosure may take the form of a computer program product on a computer-usable storage medium having computer-usable program code embodied in the medium.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the phrase “at least one of A, B, and C” should be construed to mean a logical (A OR B OR C), using a non-exclusive logical OR, and should not be construed to mean “at least one of A, at least one of B, and at least one of C.” As another example, the language “at least one of A and B” (and the like) as well as “at least one of A or B” (and the like) should be interpreted as covering only A, only B, or both A and B, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof. Example sizes/models/values/ranges can have been given, although examples are not limited to the same.

The terms (and those similar to) “coupled,” “attached,” “connected,” “adjoining,” “transmitting,” “receiving,” “connected,” “engaged,” “coupled,” “adjacent,” “next to,” “on top of,” “above,” “below,” “abutting,” and “disposed,” used herein is to refer to any type of relationship, direct or indirect, between the components in question, and is to apply to electrical, mechanical, fluid, optical, electromagnetic, electromechanical, or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action is to occur, either in a direct or indirect manner. The term “set” does not necessarily exclude the empty set—in other words, in some circumstances a “set” may have zero elements. The term “non-empty set” may be used to indicate exclusion of the empty set—that is, a non-empty set must have one or more elements, but this term need not be specifically used. The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

The corresponding structures, materials, acts, and equivalents (e.g., of all means or step plus function elements) that may be in the claims below are intended to include any structure, material, or act for performing the function in combination with other claimed elements as specifically claimed. While the disclosure describes structures corresponding to claimed elements, those elements do not necessarily invoke a means plus function interpretation unless they explicitly use the signifier “means for.” Unless otherwise indicated, recitations of ranges of values are merely intended to serve as a shorthand way of referring individually to each separate value falling within the range, and each separate value is hereby incorporated into the specification as if it were individually recited. While the drawings divide elements of the disclosure into different functional blocks or action blocks, these divisions are for illustration only. According to the principles of the present disclosure, functionality can be combined in other ways such that some or all functionality from multiple separately-depicted blocks can be implemented in a single functional block; similarly, functionality depicted in a single block may be separated into multiple blocks. Unless explicitly stated as mutually exclusive, features depicted in different drawings can be combined consistent with the principles of the present disclosure.

The description of the present disclosure has been presented for purposes of illustration and description but is not intended to be exhaustive or limited to the disclosure in the form disclosed. After reading the present disclosure, many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated. The features of any dependent claim may be combined with the features of any of the independent claims or other dependent claims.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. An apparatus comprising:
a plurality of flow field channels, wherein the plurality of flow field channels includes:
a plurality of ribs connecting an inlet and an outlet in a serpentine flow design; and
a plurality of blocking ribs within the plurality of ribs.

2. The apparatus of claim 1, wherein at least a portion of the plurality of blocking ribs within the plurality of ribs are attached to a plate.

3. The apparatus of claim 1, wherein at least a portion of the plurality of blocking ribs within the plurality of ribs are attached to the plurality of ribs.

4. The apparatus of claim 3, wherein the plurality of blocking ribs attached to the plurality of ribs includes a first set of blocking ribs attached to an upper portion of the plurality of ribs.

5. The apparatus of claim 4, wherein the plurality of blocking ribs attached to the plurality of ribs further includes a second set of blocking ribs attached to a lower portion of the plurality of ribs.

6. The apparatus of claim 1, wherein gases flow in a serpentine pattern of the blocking ribs within the serpentine pattern of the plurality of ribs.

7. The apparatus of claim 1, wherein the plurality of blocking ribs within the plurality of ribs are congruent.

8. A fuel cell comprising:
a plurality of flow field channels, wherein the plurality of flow field channels includes:
a plurality of ribs connecting an inlet and an outlet in a serpentine flow design; and
a plurality of blocking ribs within the plurality of ribs.

9. The fuel cell of claim 8, wherein at least a portion of the plurality of blocking ribs within the plurality of ribs are attached to a plate.

10. The fuel cell of claim 8, wherein at least a portion of the plurality of blocking ribs within the plurality of ribs are attached to the plurality of ribs.

11. The fuel cell of claim 10, wherein the plurality of blocking ribs attached to the plurality of ribs includes a first set of blocking ribs attached to an upper portion of the plurality of ribs.

12. The fuel cell of claim 11, wherein the plurality of blocking ribs attached to the plurality of ribs further includes a second set of blocking ribs attached to a lower portion of the plurality of ribs.

13. The fuel cell of claim 8, wherein gases flow in a serpentine pattern of the blocking ribs within the serpentine pattern of the plurality of ribs.

14. The fuel cell of claim 8, wherein the plurality of blocking ribs within the plurality of ribs are congruent.

15. A method comprising:
creating a fuel cell with a plurality of flow field channels, wherein the plurality of flow field channels includes:
a plurality of ribs forming a serpentine flow design from an inlet to an outlet; and
a plurality of blocking ribs within the plurality of ribs.

16. The method of claim 15, wherein at least a portion of the plurality of blocking ribs within the plurality of ribs are attached to one of a plate and the plurality of ribs.

17. The method of claim 16, wherein the plurality of blocking ribs attached to the plurality of ribs includes a first set of blocking ribs attached to an upper portion of the plurality of ribs.

18. The method of claim 17, wherein the plurality of blocking ribs attached to the plurality of ribs further includes a second set of blocking ribs attached to a lower portion of the plurality of ribs.

19. The method of claim 15, wherein gases flow in a serpentine pattern of the blocking ribs within the serpentine pattern of the plurality of ribs.

20. The method of claim 15, wherein the plurality of blocking ribs within the plurality of ribs are congruent.
